(19) United States
(12) Patent Application Publication
(10) Pub. No.: US 2026/0104883 A1
(43) Pub. Date: Apr. 16, 2026

(54) PATCHING AND MERGING IN ENTERPRISE APPLICATION DEVELOPED BY CODELESS PLATFORM

(71) Applicant: NB Ventures, Inc., DBA GEP, Clark, NJ (US)

(72) Inventors: Subhash Makhija, South Plainfield, NJ (US); Huzaifa Matawala, Princeton, NJ (US); Arbaaz Jalil, Navi Mumbai (IN); Shivendra Singh Malik, Vasco-da-Gama (IN)

(21) Appl. No.: 18/917,179

(22) Filed: Oct. 16, 2024

(51) Int. Cl. G06F 8/65

(52) U.S. Cl. CPC G06F 8/65

(57) ABSTRACT

The present invention provides a system and method of patching and merging of application objects in enterprise application developed by codeless platform. The invention includes patching and merging by a microservice utilizing a data relationship script and an application data library.

### BACKGROUND

### 1. Technical Field

The present invention relates generally to application developed by codeless platform. More particularly, the invention relates to patching and merging of application objects in an enterprise application developed by a codeless platform.

### 2. Description of the Prior Art

Enterprise applications have undergone significant changes with increasing complexity over time. Due to dynamically changing landscape of desired functionalities in the application, the technical problems associated with structuring the application have become extremely challenging. Moreover, for enterprise applications developed through codeless platform the underlying architecture that is supposed to enable easier structuring and execution of tasks, has created additional issues due to conflicting nature of the applications developed through the codeless platform.

Generally, a developer is entrusted with the task of modifying the underlining code of the enterprise application to accommodate the operational requirement of the organization. However, there are technical and practical problems in implementing a change to the basic structure. Firstly, modifying a set of codes to introduce a new feature or operation may break another function of the enterprise application. Secondly, the amount of time it consumes for carrying out any change to the structure of the enterprise application. The change may also requires halting the execution of multiple processes in the enterprise application. Thirdly, depending on the function of the enterprise application, defining a new process flow in a complex application such as a procurement or supply chain application without disturbing the existing flows is impractical and nearly impossible. Further, any change requires a skilled developer to make changes to the complex enterprise application scenarios at system backend which may be extremely tedious considering the developer may understand only certain sections of the entire enterprise application. Moreover, the front-end requirements of the end user may not be understood to a developer in case the user requests certain changes to the flow and structure of one or more functions/sub-applications of the enterprise application. Every end user has a different operational requirement depending on industry verticals and variations based on region of operation. It is impractical to accommodate such requirements through the existing enterprise applications.

Codeless platforms empower different types of users to manage new or existing attributes, modify enterprise application functional processes, configure rules and workflow. However, in codeless platform attributes are dynamic and driven by random modifications in the process flows, so defining prioritization rules for enterprise application task management process execution on different criterions becomes challenging and complex. Moreover, the applications developed through codeless platform may have been developed by reusable codes, but these codes are restricted in their functionality due to underlining architecture and thereby create technical issues in data processing for certain functionality in the enterprise application, particularly when the functionality is dealing with dynamic data and changing flows. In such a scenario, the system is unable to make sense of the change in the flow and identify associated task modifications which disrupts the entire execution cycle of the enterprise application functions.

The operational requirements of every organization are unique. Depending on the task to be accomplished, the organization may wish to modify the data flow through the enterprise application. However, with codeless platforms, the modification for customization of any application function or modification to the data flow is not driven by changes in the code. This makes it even more complex when there are conflicting objects of an enterprise application developed by a codeless platform. Whether it is structuring of sub applications of the enterprise application, or automation of creation of application functions, or modernization of legacy systems, the conflicting objects creates scenarios that are unpredictable, and they can't be determined or forecasted with the existing solutions. Moreover, certain events like over-riding of rules or rejection of certain proposed functions while modifying the enterprise application may result in glitches which is highly undesirable.

In view of the above problems, there is a need for a data processing system and method to overcome the problems associated with the prior arts.

### SUMMARY OF INVENTION

According to an embodiment, the present invention provides a system and method of merging and patching of application object of an application developed by a codeless platform. The method includes receiving a modification to at least one application object of the application to generate at least one modified application object; and invoking by a processor coupled to an Artificial intelligence (AI) bot associating, one or more elements of the at least one modified application object with one or more internal application object elements based on a data relationship script wherein a comparison application data library is created by the AI bot for patching and merging the one or more elements of the at least one modified application object with the internal application object, wherein each of the one or more elements of the modified application object are patched and merged with the internal application object by a microservice.

In an embodiment, the patching and merging includes identifying the one or more elements of the at least one modified application object and generating a command code associated with the modified application object and storing the command code for execution of merging operation.

In another embodiment, the patching and merging includes triggering key management module for tracking source of each key-value pair based on a hierarchy of modifications, determining precedence of modification to be invoked based on a conflict resolution rule object and in response to execution of the merging operation, generating a notification to a user through the application. The conflict resolution rule object analyzes a hierarchical data structure of the application data including the modified application data and internal application data to identify precedence of modification.

In an embodiment, the invention provides a platform architecture with merging and patching in one or more SCM applications developed by a codeless platform. The architecture includes a plurality of configurable components interacting with each other in a layered architecture, a customization layer configured to customize the one or more SCM application based on at least one modified application object and at least one operation to be executed, an application layer interacting with the customization layer through one or more configurable components of the plurality of configurable components wherein the application layer is configured to organize at least one application service of the one or more SCM application with at least one modified application object, a shared framework layer communicating with the application layer through one or more configurable components of the plurality of configurable components wherein the shared framework layer is configured to fetch shared data objects for enabling execution of the at least one application service. The architecture includes a foundation layer configured for infrastructure development through one or more configurable components of the plurality of configurable components wherein the foundation layer communicates with the shared framework layer for enabling fetching of shared data objects, a data layer communicating with the foundation layer through one or more configurable components of the plurality of configurable components wherein the data layer is configured to manage database native queries mapped to the at least one operation and a process orchestrator configured to enable interaction of the plurality of configurable components in the layered architecture for executing the at least one operation and develop the one or more SCM application with the at least one modified application object.

In an advantageous aspect, the modification is not in the underlying code as in general, code is modified to accommodate rule-based requirements. Instead, the changes are made to the application that is migrated to enterprise environment. If a developer domain introduces new fields and migrates to the client domain, it may over-ride the changes by the customer. However, the present invention enables patching and merging to avoid conflict. The patching takes developer domain application function and merges it with a client domain application function. The patching function is a set of commands with recoding of every action. For eg: adding field X or modified field X on the application interface triggers a command generation that is stored. Based on Artificial intelligence (AI) analysis of the recoded actions, the patching and merging function is performed to avoid conflict.

In another advantageous aspect, the present invention utilizes Machine Learning algorithms, prediction data models, artificial intelligence-based process orchestrator for execution of one or more SCM application operations.

### BRIEF DESCRIPTION OF THE DRAWINGS

The disclosure will be better understood and when consideration is given to the drawings and the detailed description which follows. Such description makes reference to the annexed drawings wherein:

FIG. 1 is a data processing system for patching and merging of application objects of an application developed by a codeless platform in accordance with an embodiment of the invention.

FIG. 2 is a flow diagram depicting localization of submit and status 1 key in accordance with an example embodiment of the invention.

FIG. 3 is a flow diagram depicting an invoice package with localization values as submit and draft invoice in accordance with an embodiment of the invention.

FIG. 4 is a flow diagram depicting overriding of value of key status and storing it as part of the node in accordance with an embodiment of the invention.

FIG. 5 is a flow diagram depicting deploying a package with key set submit, cancel and status in accordance with an embodiment of the invention.

FIG. 6 is a flow chart depicting a method of patching and merging in accordance with an embodiment of the invention.

FIG. 7 is a flow diagram of vulnerability determination in accordance with an embodiment of the invention.

FIG. 8 shows a Widget builder platform as a field of field UI builder system with multiple modules and flows in accordance with an embodiment of the present invention.

FIG. 8A shows plugins through messaging bus pattern in accordance with an embodiment of the present invention.

FIG. 9 shows the widget builder platform with multiple modules and process flow for adding a field on an application UI in accordance with an embodiment of the present invention.

### DETAILED DESCRIPTION

Described herein are the various embodiments of the present invention, which includes systems and methods for merging and patching of application object of an enterprise application including supply chain management applications.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “customization layer,” “application layer,” “foundation layer” or “data layer,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to codeless development platform, system and method for merging and patching of an application object of an enterprise application including supply chain management application.

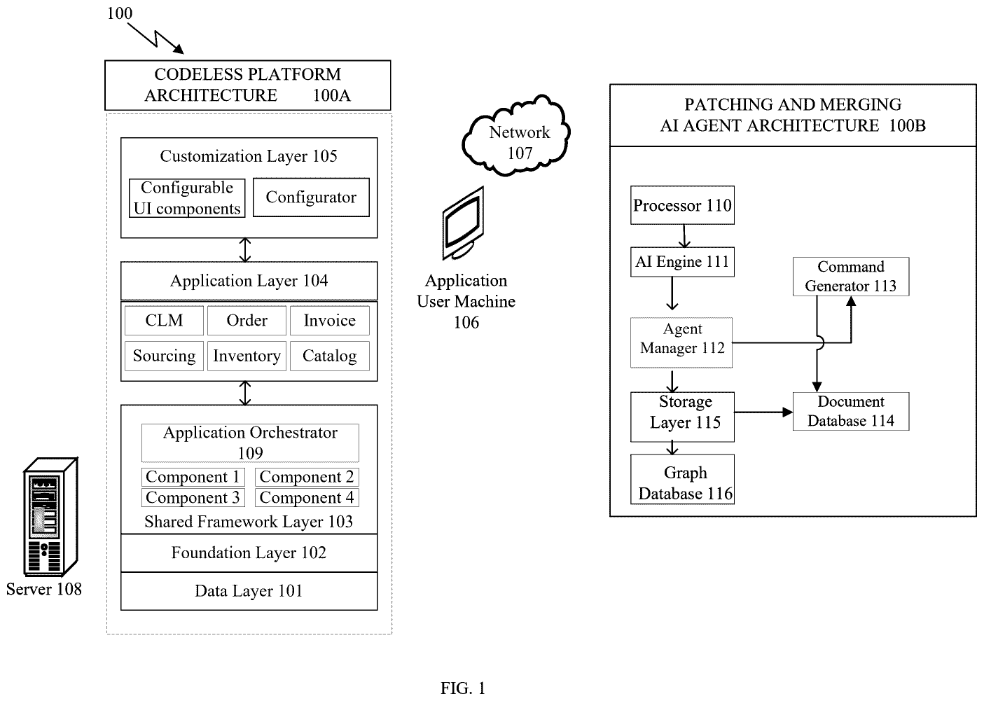

Referring to FIG. 1, an architecture diagram of a data processing system 100 with merging and patching of application objects in an enterprise application developed by a codeless platform is provided in accordance with an embodiment of the present invention. The architecture of the data processing system includes a codeless platform architecture 100A and a patching and merging AI agent architecture 100B.

The codeless platform architecture 100A of the system 100 is a layered architecture 100A configured to process complex operations of one or more applications including supply chain management (SCM) applications using configurable components of each layer of the architecture 100A. The layered architecture enables faster processing of complex operations as the workflow may be reorganized dynamically using the configurable components. The layered architecture includes a data layer 101, a foundation layer 102, a shared framework layer 103, an application layer 104 and a customization layer 105. Each layer of the codeless platform architecture 100A includes a plurality of configurable components interacting with each other to execute at least one operation of the SCM enterprise application. It shall be apparent to a person skilled in the art that while FIG. 1 provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine, and a platform developer user through its computing device triggers the shared framework layer 103, the foundation layer 102 and the data layer 101 to structure the platform for enabling codeless development of SCM applications. Since, both client domain side user and developer domain side user have the ability to modify the application or application objects, the interaction with each of the layers of the architecture creates challenges for acceptance of the modification to the application objects, particularly in case of conflict or vulnerability determination.

In an embodiment the present invention provides one or more SCM enterprise application with an end user application UI and a citizen developer user application UI for structuring the interface to carry out the required operations. Further, the layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the reconfiguration of the system to manage the related changes in the task is cumbersome. Moreover, in case the changes are conflicting with the changes done by a client domain user, the system needs to understand the context of the changes and readjust the process flows, application objects on an interface of the application after determining vulnerabilities associated with the changes.

In one embodiment, the codeless platform architecture 100A provides the cloud agnostic data layer 101 as a bottom layer of the architecture. This layer provides a set of micro-services that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP—online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

In an embodiment the platform architecture provides 100A the foundation layer 102 on top of the data layer 101 of the architecture 100A. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permission) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In a related embodiment, the plurality of configurable components includes one or more shared framework configurable components including but not limited to license manager, Esign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, the architecture 100A provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer domain user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of application orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, the architecture 100A provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with a application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence (AI) based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by server processor. The electronic circuitry has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low-speed interface connecting to low-speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high-speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system of the present invention includes a front-end web server communicatively coupled to at least one database server, where the front-end web server is configured to process the dataset characteristic data based on one or more data models and applying an AI based dynamic processing logic to automate execution of the task in the application developed by the codeless development actions through process orchestrator.

In an embodiment, the platform architecture 100A of the invention includes an application orchestrator 109 configured for enabling interaction of the plurality of configurable components in the layered architecture 100 for executing at least one SCM application operation and development of the one or more SCM application. The application orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based application orchestration engine configured for interacting with a plurality of configurable components in the platform architecture for executing SCM operations.

In an embodiment, application orchestrator 109 includes a service connector for integrating different services with the one or more SCM application and interaction with one or more configurable components. Further, Configurator User interface (UI) services are used to include third party networks managed by domain providers.

In a related aspect, the Artificial intelligence (AI) based orchestrator engine enables execution of SCM operation by at least one data model wherein the AI engine 111 transfers processed data to the UI for visibility, exposes SCM operations through API and assist the manager for application orchestration and control.

In an exemplary embodiment, the AI engine employs machine learning techniques that learn patterns and generate insights from the data for enabling the process orchestrator to automate operations. Further, the AI engine with ML employs deep learning that utilizes artificial neural networks to mimic biological neural network in human brains. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for operating one or more SCM enterprise application.

In an embodiment, the system 100 of the present invention includes a workflow engine that enables monitoring of workflow across the SCM applications. The workflow engine with the application orchestrator 109 enables the platform architecture to create multiple application workflows based on the task to be executed.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an embodiment, the patching and merging AI Agent architecture 100B includes a processor 110 coupled to an AI engine 111 configured for executing one or more task. The processor is configured for associating one or more elements of at least one modified application object with one or more internal application object elements based on a data relationship script. The processor 110 serves as the bridge between the different users and the backend components of the patching and merging AI Agent architecture. The AI Agent architecture 100B includes an AI agent manager 112, a command generator 113 and a storage layer 114. The AI agent manager 112 is configured to trigger the command generator 113 for generating a command code in response to modification of the application objects and storing the command in a document database 114. The architecture 100B includes AI agents including domain model (DM) AI agent, application function AI agent, and execution agent. Architecture includes a storage layer 115 configured for storing one or more AI agents and domain specific AI tools for executing the patching and merging operations. The architecture 100B also includes a graph database 116 configured for providing information based on the data relationship script wherein a hierarchical structure of the graphical database enables application development optimization based on identified relationship between the at least one modified application object and the one or more internal application object.

The processor 110 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user/demand planner and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In an example embodiment, the tools for executing AI agent functions of modifying application objects by executing a deterministic flow of logic include interface library-based functions. For eg: Python functions could wrap multiple utilities in them such as machine learning (ML) model and LLM executors etc. The tools also include application programming interface (API) executors that executes API calls when requested. The system includes a set of API executors of all major API's form part of the toolbox. Further, the tools also include databases and data source connector tools. The tool includes machine learning based data models or large language models (LLM) with access to a bundle of tools to achieve the objectives. These agents are driven by prompt(s) configured to enable process orchestration and tool selection.

In an embodiment, the AI agent architecture 100B includes the storage layer 114 configured to keep track of all the required data or information generated during data processing. This component of the architecture 100B, is configured for storing information such as memory objects, the selected tools, the state of execution and the error messages among others.

In an exemplary embodiment, the memory or storage layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an exemplary embodiment, the patching and merging system of the invention includes a graph-based database design structured to optimize application development and deployment on the codeless platform. The structure is hierarchical, promoting modularity and reuse of components. The levels of abstraction include domains, application group, and task module. The domains represent various environments, in which the applications are structured or created. The most granular level is the developer domain, then Industry, client and Production as we move upwards in the hierarchy. The application group is logical grouping of modules where each application houses multiple modules tailored to specific tasks or functionalities. The task module is deployment unit within the application where a module encapsulated multiple components including Localization configured to handle language translations and region-specific content, CDS as a service facilitating HTTP calls, Plugins as extensions or add-ons enhancing the module's capabilities, Widgets representing individual pages or user interface components and Domain Model that defines the data structures and business logic.

In an exemplary embodiment, the patching and merging of application object of an application developed by a codeless platform includes a task of associating one or more elements of at least one modified application object with one or more internal application object elements based on a data relationship script. The patching and merging system includes an artificial intelligence (AI) bot configured for creating a comparison application data library for patching and merging the one or more elements of the at least on modified application object with the internal application object.

In an embodiment, the application object includes front end or backend object components of the application including data object, meta data, application workflow components, and UI components associated with execution of operations in a supply chain application. The back-end object components include domain model, rule, application process model, State Machine, approval rule engine, and code snippet in microservice. The front-end object components include front rule User Interface (UI) behavior, form elements, labels, fields, sections, and buttons based on state machine.

In an embodiment, the bot deploys the front end and back-end object components of the application into a single node pattern with an application data structure and an augmented application data structure wherein the augmented application data structure shares one or more resources with the application data structure and enables modification of the application object.

In an embodiment, the data relationship script enables fetching information from a graph database wherein a hierarchical structure of the graphical database enables application development optimization based on identified relationship between the at least one modified application object and the one or more internal application object.

In a related embodiment, the data object of the application is stored as a graph structure enabling identification and association of data object relationships.

In another embodiment, the microservice includes application microservice such as custom logic, code generation, document creation, and API support authentication.

In an exemplary embodiment, the comparison application data library includes source data, destination data, versioning data, entity code and an identifier code wherein the identifier code is generated by the processor based on the data relationship script.

In an embodiment, the patching and merging method of the invention includes triggering by the AI bot, a domain model having one or more application entities with their relationship to other entities represented by associations wherein one or more annotations connected to the domain model enables identification of means by which the domain model is to be operated.

In an embodiment, associations between entities are critical to effective modeling as without them, the model is just a vocabulary of broad terms since it lacks the collaborative context. They can be used to create more complex structures, by referencing or composing entities.

In a related example embodiment, the type of associations include reference where both entities can exist independently and still have operational value like Order and Supplier. Also, the association includes composition where a particular type of entity association, modeling a part of a whole relationship between the composite and a group of parts. The items or data records of composed entities are bound, so removing the whole would also delete the parts like Order and Order schedule.

In an embodiment, the structure of the domain model captures operational information and operational rules associated with the elements of the one or more internal application objects. The application objects associated with the domain model enables support for spatial data editor (SAGA) and compensation of transaction to avoid orphan metadata.

In an exemplary embodiment, Domain Model has a wrapper to connect to various database types. Object Mapper is responsible to convert domain model to data model as per schema defined. The CRUD (Create, read, update and delete) Operations exposed by Domain Model has operational rules validations, Mandatory check, Defaulting etc. APIs exposed by domain model are mapped to application objects like Form Designer and CRUD operations for transaction.

In an exemplary embodiment, the patching and merging method of the invention includes creating one or more application object data relationship model as an ensemble of one or more data models for generating a relationship prediction data model to enable the data relationship script to associate one or more modified application object with internal application object by a bot.

In an embodiment, the patching and merging operation includes identifying by an implementation bot, one or more application module intended to implement the modified application object based on an application object implementation prediction data model.

In a related embodiment, the application object implementation prediction data model is generated by retrieving one or more historical application data object elements from a historical data object elements graph database, extracting a plurality of relationship categories from the graph database to create a taxonomy of relationships associated with the application data object elements, and invoking by the processor, one or more application module operational logic associated with each of the application module of the application based on the application object elements for generating an execution pattern between one or more application data object elements for generating the prediction data model.

In an example embodiment, the invention provides an application development scenario. The invention enables creation of application group on developer domain and within this group Customer order and Supplier order is created as modules. Each module has its own set of localizations, CDS, plugins, widgets and domain models. The localization component of the Customer Order module includes localization keys as unique key identifier for each piece of translatable content. For Eg: a key “Submit”. Whenever a localization key (Eg,. Submit) is added to a module, the actual value (translation) is stored at a global or common level. This design choice ensures that any change in the translation value is reflected across all modules referencing that key to promote consistency. Further, each modification to a translation spawns a new version. For instance, if “Submit” originally translated to “Save” but is later changed to “Save Document”, the newer translation becomes the latest version. While the latest version is typically active (i.e., the one retrieved when the key is referenced), users retain the flexibility to activate any prior version, ensuring control and flexibility. For fetching operation, when a module requires the value of a localization key, it doesn't fetch the value directly from within. Instead, it references the global/common level. The active version of the key at the global level is what gets retrieved, ensuring that all modules consistently present the most up-to-date or designated translations.

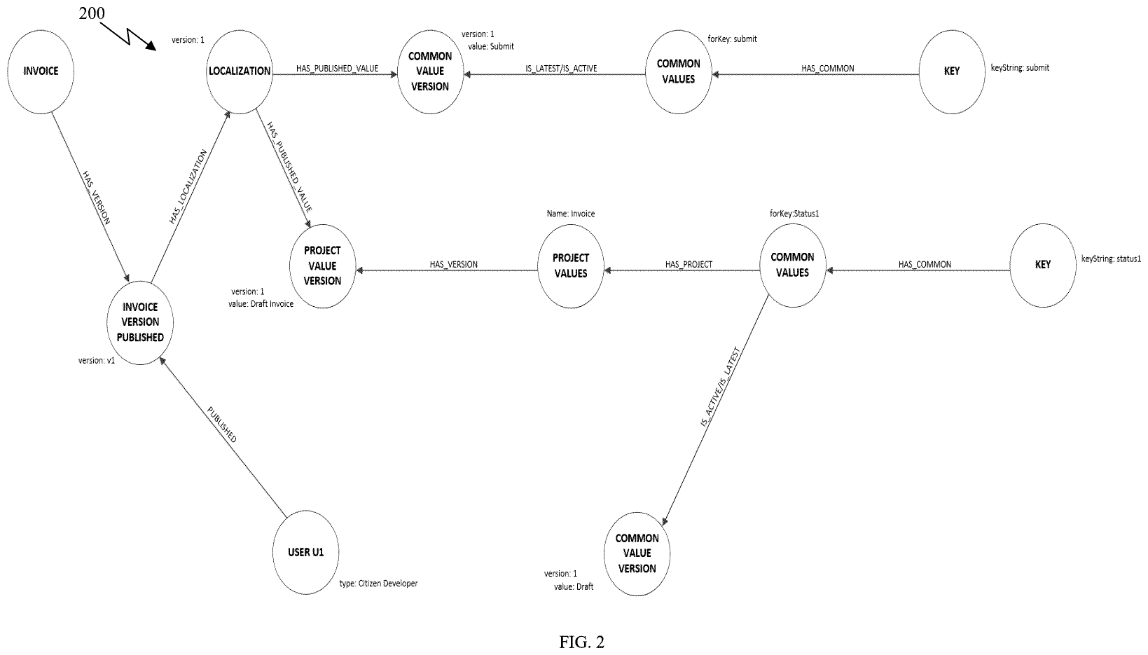

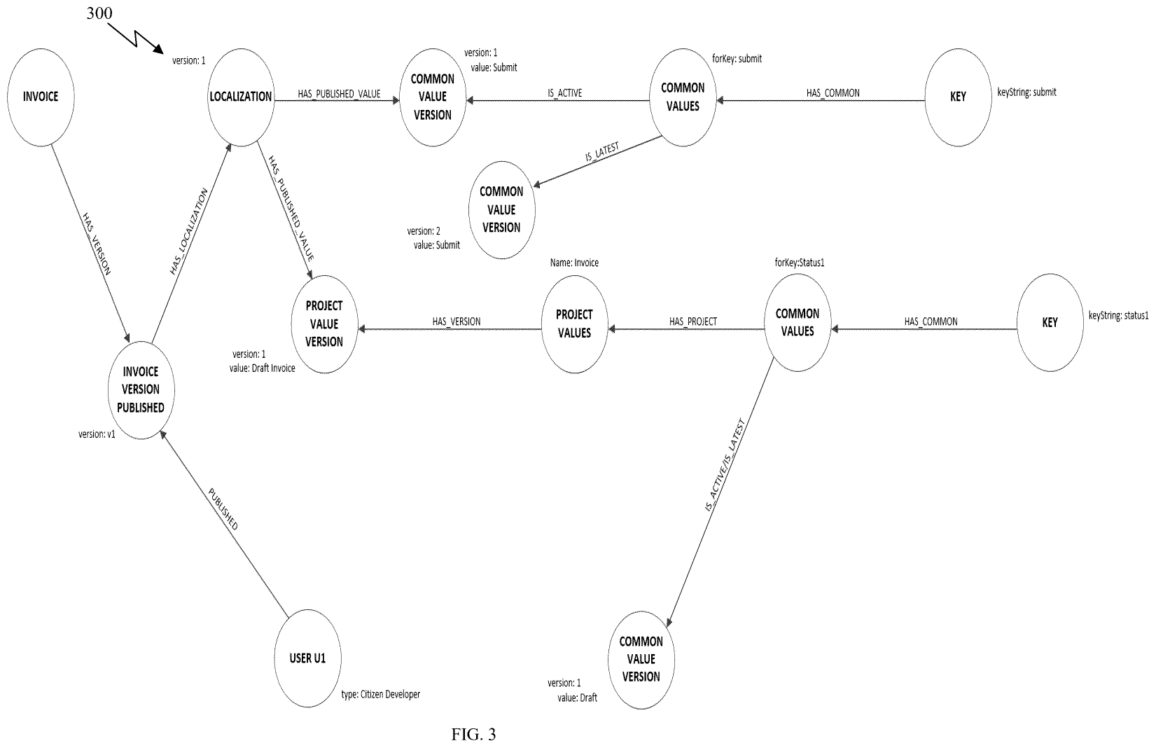

In an example embodiment, an implementation scenario where a user “U1” designated as a Citizen developer has created or published a version of a package which contains localization information of two keys: Submit and status1 is provided. Referring to FIGS. 2 and 3, a graph node design 200, 300 of the implementation scenarios is shown. The design includes a) user and module interaction where U1, a citizen developer creates or publishes a specific version of a package/module like invoice module with different versions (like version 1 (v1) in the graph) tagged as “published”; b) localization implementation with submit and status 1 key as unique key identifiers for localization entry, common values representing global or default localization values associated with the key and shared across projects unless overridden at project level, common values version, project values representing project specific or module specific values for a localization key and overriding common values, project value version as status 1 has project value of “Draft Invoice” for the invoice module; c) Value retrieval logic where for the submit key, the invoice module would reference the common values, which is Submit, and for the status 1 Key the invoice module would reference project specific value, which is “Draft invoice” that will override the common value “Draft”; d) Notification and Updates where, an update to a common value by a translation team creates a new version node and all projects or modules referencing that common value are informed about the update to ensure they have the recent localization information. In short, the graph captures the dynamics of how localization is managed at both the global (Common) level and the project-specific level. It ensures that modules can have default translations while still providing the flexibility to override these values as needed.

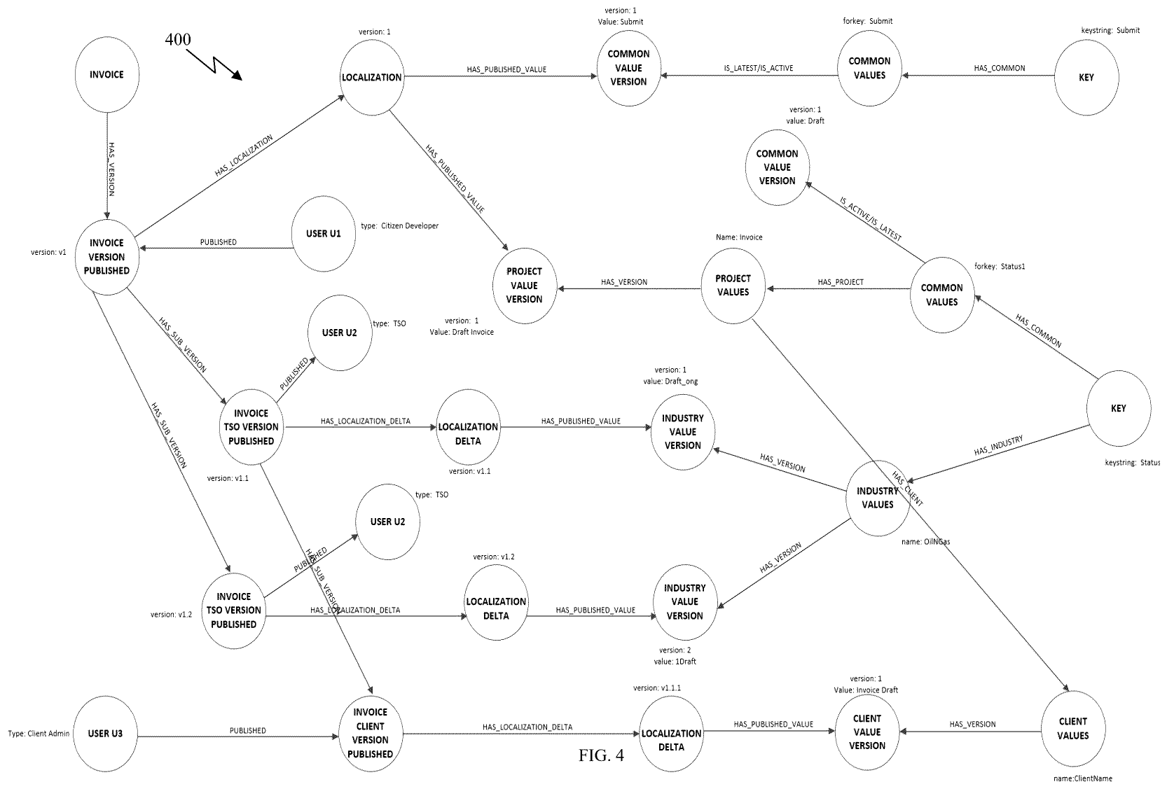

In an exemplary embodiment, for patching and merging operation with invoice application object, a graph design node structure 400 is provided as shown in FIG. 4. The structure provides a base level common localization with default localization values. All modules/projects use these values unless they have their own specific overrides. The nodes “Common Value version” hold these base values. The structure also provides project/module level (developer domain—Layer 1) where any module or project can override the default localization values. This is shown in “Project value” nodes where, while etching a value, if the module has an override, this value will be used over the base value. The design structure includes industry level (Industry domain—Layer 2) where, if an industry specific version of a module has overrides, these take precedence over both the project/module level and the base level. This is also seen in “Industry value version” nodes. Considering, this hierarchy, For Invoice v1 (Developer domain), when fetching the status key, the system returns “Draft invoice” as it has a project-level override in the “Project value” node that takes precedence over the common level. For Invoice v1.1 (Industry Layer), when fetching the “Status” Key, it will return “Draft_ong” because it has an industry-level override in the “Industry Value Version” node, which takes precedence over both the project/module level and the base level. For Invoice v1.2 (Industry Layer), when fetching the “Status Key”, it will return “1Draft” due to the industry-level override.

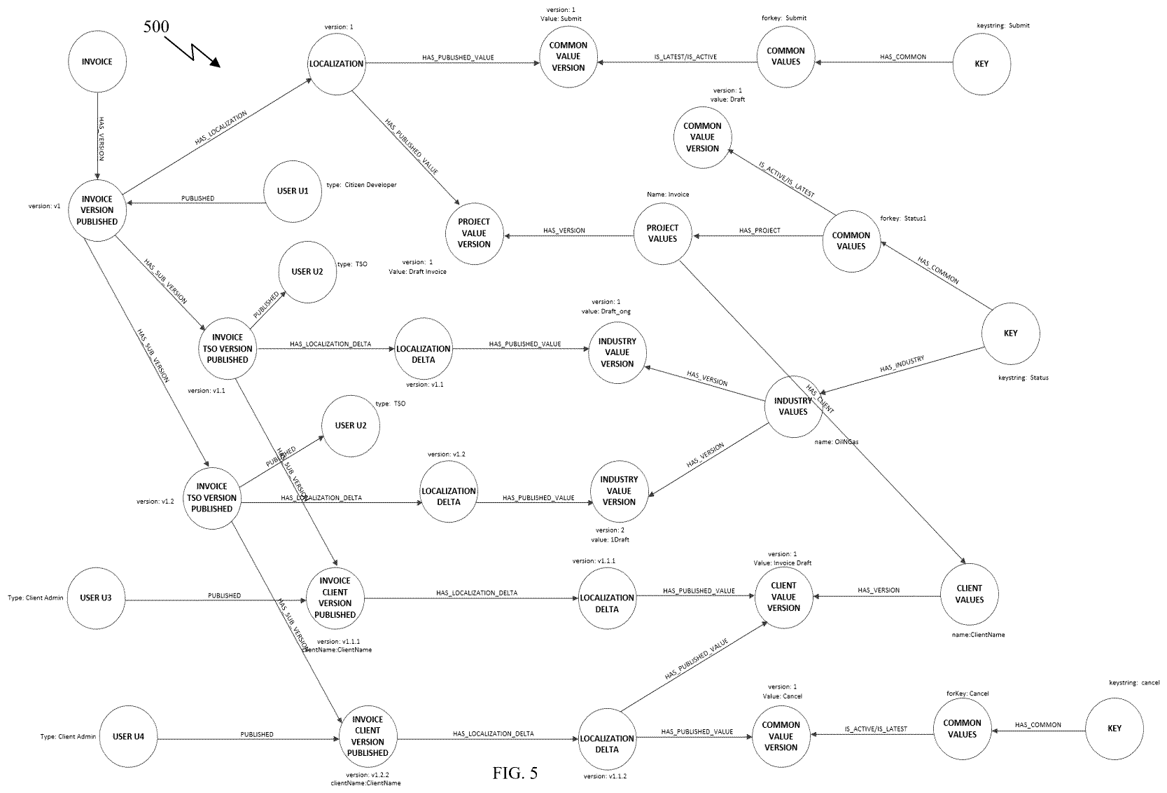

In a related embodiment, the layered and versioned structure of the patching and merging system provides the base layer (common values) as version 1 containing two keys “Draft” (for the status) and “Submit” (for the action) as these are the default values and sever as the base layer. The User levels or the Development layer include various users including citizen developers, operational users, technical users etc., having the ability to create new versions of the invoice (eg, v1.1, v1.2) by taking the common values as a starting point. In these versions, the users can override the values of the existing keys from the common space and any new keys introduced at this level would be added to the common space. The system also provides a client layer where, a specific client (as indicated in the node “Client Admin”) has the opportunity to further create a version (v1.1.1) based on v1.1. In this version (v1.1.1), they have the choice to override values for the “status” and “Submit” keys. Additionally, a new key “Cancel is introduced at this layer which is added to the common space as shown in graph node design 500 in FIG. 5.

In another related embodiment, the system provides key management that ensures there's a robust system in place to track the source of each key-value pair. This helps in tracing back any modifications and provides a clear hierarchy of overrides. The system also provides versioning, where semantic versioning or similar structured approach to manage the different versions of the invoice is adopted to easily identify the layer and source of changes. Since, there are multiple layers where values can be overridden, there should be a clear mechanism to resolve conflicts. For instance, if two layers try to override the same key with different values, which one takes precedence? The system maintains comprehensive documentation detailing the flow, the layers involved, and the rules governing the addition and modification of keys. The system incorporates an audit trail feature, capturing every change, the user who made it, the timestamp, and the layer at which it was made. This aids in troubleshooting and ensures accountability. Further, the system implements a notification mechanism to alert relevant stakeholders whenever there's a change or a new key addition, ensuring everyone is updated.

In an exemplary embodiment, each module i.e localization, Widget etc., of the present invention includes a dedicated wrapper microservice configured for applying the patching mechanism on the document database records of the project version which is being published. The payload for the wrapper microservice is provides as:

```
{“source”: {
    “draftId”: “string”,
    “project”: “string”,
    “version”: “string”},
  “destination”: {
    “project”: “string”,
    “version”: “string”},
  “toVersion”: “string”,
  “bpc”: {“code”: 0,
    “environment”: “string”},
  “systemGeneratedDraftId”: “string”}.
```

The wrapper payload includes a “Source” that carries information of the Source. In case of a standard publish (which occurs from a draft), only the “draftId” value is sent in the “Source”. Another case where we are trying to merge two project versions, only “project” and “version” is to be sent in the “Source”. Further, the wrapper payload includes “Destination” that is always a project version. This is so because in case of standard publish the patches from the draft will act like a Source and the Project Version from which the draft was created will act like a Destination. In case two different Project Versions are supposed to be merged, the Destination Project's accumulated patches will run on top of the Source Project's BaseObjects. The “ToVersion” value indicates the new project version that will be created by the Source and Destination. The Wrapper payload includes “Bpc” that associates the Project version being published for a specific Buyer Partner code. Also, the payload provides “SystemGeneratedDraftId”. In case the Project Version that is being published, is being published for the first time in a new layer above, a draft is being created automatically by the bpmn before the wrapper APIs are called for each module (Localization Wrapper, Widget Wrapper etc). The draft created has an id which is being passed as the System Generated DraftId at that time.

In an example embodiment, the design of the wrapper includes two types of conditional flows decided depending upon whether the publish is happening on the same layer (draftId is always involved) or inter-layer (draftId is not involved, only Project Versions are involved). The flow of the wrapper is as below:

//Publishing from draft to a new Project version
if (publishRequest.Source.DraftId ! = null && publisRequest.Source.Project == null &&
publishRequest.Source.Version == null)
{
//Destination is project and source is draft with patches
PublisheManager publishmanager = new PublishManager (Utilityservice);
Draft Source=new Draft( ) { Draftid = publishRequest.Source.Draft };
Project Destination = new Project( ) { Id = publishRequest.Destination.Project, version =
publishRequest.Destination.Version };
publishmanager.SetSameLayerPackage(new SameLayerPackages( ) { Source = Source,
Destination = Destination, toversion = publishRequest.Toversion});
//Destination is project and source is draft with patches
if (!isFirstVersion(Destination))
{return publishmanager.SameLayer.NotFirstVersion( );}
else
{return publishmanager.SameLayer.Firstversion( );}
//publish from existing Project version to Existing/Non-Existing Project Version
else if (publishRequest.Source.Draftid == null && publishRequest.Source.Project != null &&
publishRequest.Source.Version != null)
{
Project Source = new Project( ) {Id = publishRequest.Source.Project, Version =
publishRequest.Source.Version };
Project Destination new Project( ) (Id = publishRequest.Destination.Project, Version =
publishtequest.Destination.Version };
PatchManager.Bpc bpc =new PatchManager.Bpc( ) { code publishRequest.Bpc.code, environment
= publishRequest.Bpc.environment };
var destinationPublishedVersion = Utilityservice.GetPackageByPublishedversion(Destination);
PublishManager publishManager = new PublishManager(Utilityservice);
publishManager.SetInterLayerPackage(new InterLayerPackages( ) { Bpc = bpc, Source = Source,
Destination = Destination, toVersion = publishRequest.ToVersion};
if (destinationPublishedVersion != null)
{return publishanager.InterLayerPublish.NetFirstVersion( );}
else
{return publishManager.InterLayerPublish.FirstVersion( );}}

In a related embodiment, for the Same Layer a draftId is sent to the Source and the Destination is the project version from which the draft is created. Within this conditional flow, two more conditional flows exist as: (1) FirstVersion( )→This conditional flow is followed when the draft is created from version “v0” (i.e. first draft ever). This conditional flow will assume that all the entities are having an empty BaseObject and session patches from the draft will be simply run on top of an EMPTY BaseObject, and (2) NotFirstVersion( )→This conditional flow is followed when the draft is NOT created from version “v0”. This will take the BaseObject from the document database records for running the patches. Any entity which is common between the draft and the parent project version will be published by taking the session patches and running them on top of the baseObject from the parent project version. Any entity which is added in the draft is published by taking session patches of the entity that was added and run them on top of an empty BaseObject. This takes care of publishing within the same layer eg. Industry→Industry, Client→Client). Further, for the Inter Layer two conditional flow exists as: (1) FirstVersion( )→This conditional flow is followed when the Destination Project Version does not exist, which means that the Source Project Version is being published onto an upper layer environment for the first time. In this case the referenceIds of the Source BaseObject records are passed onto the new BaseObject of the new project version that is being created on the upper layer environment. This is where a draft is generated automatically by the data models in the background i.e. SystemGeneratedDraft). (2) NotFirstVersion( )→This conditional flow is followed when we are trying to MERGE two existing Project Versions.

In an exemplary embodiment, the Merging scenario is explained below with an example from the views in the Widgets module as:

Case 1: View exists in both the Source and the Destination
Patching Mechanism=>
Take BaseObject from Source + Accumulated Patches from Destination = New BaseObject
View123 (at Source)=>
{“referenceId”:“c60dba28-3aac-428f-9936-4de1a1462f61” “base”:{“label”:“Field Name”,
“properties”:{“isVisible” : true, “isLeftAllign”: false}}}
Accumulated patches for View123 at Destination =>
{“patchPath”: “properties.isVisible”, “patchValue”: false}
New BaseObject at New ProjectVersion for View123 =>
{“referenceId”:“y90dba28-3aac-428f-9936-4de1a1462f61” “base”:{“label”:“Field Name”,
“properties”:{“isVisible”: false, “isLeftAllign”: false}}}.
Case 2: View exists exclusively in Source
Patching Mechanism=>
Carry reference of the Source BaseObject to Destination
View123 (at Source)=>
{“referenceId”:“c60dba28-3aac-428f-9936-4de1a1462f61” “base”:{“label”:“Field Name”,
“properties”:{“isVisible” : true, “isLeftAllign”: false}}}
Since View123 dosent exists in Source
New BaseObject at New ProjectVersion for View123 =>
{“referenceId”:“y90dba28-3aac-428f-9936-4de1a1462f61” “base”:“c60dba28-3aac-428f-9936-
4de1a1462f61” //reference of the baseObject from Source}
Case 3: View exists exclusively in Destination
Patching Mechanism=>
Carry BaseObject as it is to Destination
View123 (at Destination)=>
{“referenceId”:“c60dba28-3aac-428f-9936-4de1a1462f61” “base”:{“label”:“Field Name”,
“properties”:{“isVisible” : true, “isLeftAllign”: false}}}
Since View123 is present exclusively in Destination, this means View123 is not being carried
from lower layer to upper layer, hence the BaseObject can be carried in the new ProjectVersion
as it is. New BaseObject at New ProjectVersion for View123 =>
{“referenceId”:“y90dba28-3aac-428f-9936-4de1a1462f61” “base”:{“label”:“Field Name”,
“properties”:{“isVisible” : true, “isLeftAllign”: false}}}.

In an example embodiment, the patching and merging operation in the codeless platform record all actions performed by users as patches. These patches can then be used to merge different versions of an application between two environments: the Developer Domain and the Client Domain. This allows for seamless integration of application customizations while retaining necessary updates from the original source.

In an example workflow, the patching and merging operation includes step 1 of initial application version with developer and client domain. In Developer Domain (v1) the application contains a widget manager (widgetManager) with a section (wm001) that has one field, First Name (field001), with a maximum length of 50 characters. This version is migrated to the Client Domain, making both domains identical. The developer Domain code as an example is provided as:

{ “widgetManager”: { “id”: “wm001”, “sections”: [{ “id”: “section001”, “sectionName”:
“Personal Information”, “fields”: [{ “id”: “field001”, “label”: “First Name”, “type”: “text”,
“maxlength”: 50, “required”: true, “placeholder”: “Enter your first name” }] }] } }

The Client Domain is isdentical to the Developer domain at the initial stage. The Client Domain v1.0 (after migration) as an example is provided as:

{ “widgetManager”: { “id”: “wm001”, “sections”: [{ “id”: “section001”, “sectionName”:
“Personal Information”, “fields”: [{ “id”: “field001”, “label”: “First Name”, “type”: “text”,
“maxlength”: 50, “required”: true, “placeholder”: “Enter your first name” }] }] } }.

In next step, the application customization is executed as:
Client Domain (v1.1): The First Name field's maximum length is changed from 50 to 100. A new field, Last Name (field002), is added to the section. The changes between v1.0 and v1.1 are captured as patches and stored in the database. The payload for generating these patches is as follows:

{ “left”: { “widgetManager”: { “Id”: “wm001”, “sections”: [{ “Id”: “section001”, “sectionName”:
“Personal Information”, “fields”: [{ “Id”: “field001”, “label”: “First Name”, “type”: “text”,
“maxlength”: 50, “required”: true, “placeholder”: “Enter your first name” }] }] } }, “right”: {
“widgetManager”: { “Id”: “wm001”, “sections”: [{ “Id”: “section001”, “sectionName”: “Personal
Information”, “fields”: [{ “Id”: “field001”, “label”: “First Name”, “type”: “text”, “maxlength”:
100, “required”: true, “placeholder”: “Enter your first name” }, { “Id”: “field002”, “label”: “Last
Name”, “type”: “text”, “maxlength”: 50, “required”: true, “placeholder”: “Enter your last name”
}] }] } } }.

The Output patch, stored in the database is:

[ { “Path”: “widgetManager.sections:section001.fields:field001.maxlength”, “LeftValue”: 50,
“RightValue”: 100, “Op”: “replace” }, { “Path”:
“widgetManager.sections:section001.fields:field002”, “LeftValue”: null, “RightValue”: { “Id”:
“field002”, “label”: “Last Name”, “type”: “text”, “maxlength”: 50, “required”: true,
“placeholder”: “Enter your last name” }, “Op”: “add” } ]. This represents the application
customizations.

In next step, the developer domain update is executed. Developer Domain (v2): A new field called PhoneNumber (field003) is added. The First Name field remains unchanged with a maxlength of 50. The developer Domain V2 as an example is provided as:

{ “widgetManager”: { “Id”: “wm001”, “sections”: [{ “Id”: “section001”, “sectionName”:
“Personal Information”, “fields”: [{ “Id”: “field001”, “label”: “First Name”, “type”: “text”,
“maxlength”: 50, “required”: true, “placeholder”: “Enter your first name” }, { “Id”: “field003”,
“label”: “PhoneNumber”, “type”: “text”, “maxlength”: 50, “required”: true, “placeholder”: “Enter
your phone number” }] }] } }. At this point, Developer Domain (v2) has First Name (maxlength
= 50) and PhoneNumber. Client Domain (v1.1) has First Name (maxlength = 100) and Last
Name.

In the final step, the latest version of the developer domain (v2) is merged with the latest version of the Client domain (v1.1). The merging operation analyses the application customizations and applies them accordingly.

In an exemplary embodiment, the patch generating algorithm is provided with the following payload:

{ “left”: { “widgetManager”: { “Id”: “wm001”, “sections”: [{ “Id”: “section001”, “sectionName”:
“Personal Information”, “fields”: [{ “Id”: “field001”, “label”: “First Name”, “type”: “text”,
“maxlength”: 50, “required”: true, “placeholder”: “Enter your first name” }, { “Id”: “field003”,
“label”: “PhoneNumber”, “type”: “text”, “maxlength”: 50, “required”: true, “placeholder”: “Enter
your phone number” }] }] } }, “selected”: [ { “Path”:
“widgetManager.sections:section001.fields:field001.maxlength”, “LeftValue”: 50, “RightValue”:
100, “Op”: “replace” }, { “Path”: “widgetManager.sections:section001.fields:field002”,
“LeftValue”: null, “RightValue”: { “Id”: “field002”, “label”: “Last Name”, “type”: “text”,
“maxlength”: 50, “required”: true, “placeholder”: “Enter your last name” }, “Op”: “add” } ] }.
This generates the following merged metadata:
{ “widgetManager”: { “Id”: “wm001”, “sections”: [{ “Id”: “section001”, “sectionName”:
“Personal Information”, “fields”: [{ “Id”: “field001”, “label”: “First Name”, “type”: “text”,
“maxlength”: 100, “required”: true, “placeholder”: “Enter your first name” }, { “Id”: “field003”,
“label”: “PhoneNumber”, “type”: “text”, “maxlength”: 50, “required”: true, “placeholder”: “Enter
your phone number” }, { “Id”: “field002”, “label”: “Last Name”, “type”: “text”, “maxlength”: 50,
“required”: true, “placeholder”: “Enter your last name” }] }] } }.

The Client Domain has a new version of the application metadata that includes First Name with a maxlength of 100 (client customization), Last Name (client-added field), PhoneNumber (developer-added field). The AI bots analyze the application parameters and functions to be executed before identifying precedence where applicable, and new fields from the developer domain are seamlessly integrated.

The purpose and usage of Generate ( ) and merge ( ) in an example is provided as:

[HttpPost] [Route(“Generate”)] public string Generate([FromBody] object obj) { var objParsed =
JObject.Parse(obj.ToString( )); var left = JToken.Parse(objParsed[“left”].ToString( )); var right =
JToken.Parse(objParsed[“right”].ToString( )); List patchOperations =
GenerateOptimizedJsonPatch(left, right); return
Newtonsoft.Json.JsonConvert.SerializeObject(patchOperations); } [HttpPost] [Route(“Merge”)]
public string Merge([FromBody] object obj) { var objParsed = JObject.Parse(obj.ToString( )); var
left = JToken.Parse(objParsed[“left”].ToString( )); var selected =
JToken.Parse(objParsed[“selected”].ToString( )); var userSelectedDifferences =
Newtonsoft.Json.JsonConvert.DeserializeObject<List>(selected.ToString( )); // Merge the JSON
objects based on the user-selected differences JToken mergedJson = ApplyPatch(left,
userSelectedDifferences); return Newtonsoft.Json.JsonConvert.SerializeObject(mergedJson); ;
//return Newtonsoft.Json.JsonConvert.SerializeObject(patches); }

In a related embodiment, the Generate ( ) Method is invoked by the AI bot when the differences between two versions of application metadata is to be determined. This is typically used after changes or customizations are made by the application/client user. It compares two JSON objects left (the original version) and right (the customized version) and generates a list of patch operations that capture the differences between them. The Metadata passed is as: In Step 2, pass:
left: Client Domain v1.0 (the original version migrated from the Developer Domain).
right: Client Domain v1.1 (the version modified by the client with changes like increasing First Name maxlength to 100 and adding the Last Name field).

In another related embodiment, the Merge ( ) method is invoked by the AI bot when the latest version of the Developer Domain is to be merged with the customized version of the Client Domain. After the client and developer both make changes, this method merges the selected differences into the developer's version. It applies a selected list of patch operations (previously generated using Generate ( ) to the left metadata, effectively creating a merged version that incorporates both client and developer changes. The Metadata passed is as: In Step 4, pass: left: Developer Domain v2 (the latest version of the developer's app, which includes a newly added PhoneNumber field).
selected: The list of patch operations representing the client's customizations, such as updating First Name maxlength to 100 and adding the Last Name field.
These methods work together to ensure that both client customizations and developer updates are seamlessly integrated into the final merged version of the application.
The extended code for the generate and merge operation is provided as:

private static void GenerateOptimizedJsonPatchInternal(JToken source, JToken target, List
patchOperations, string { if (source.Type != target.Type) { patchOperations.Add(new
JsonPatchOperation { Operation = “replace”, Path = currentPath, Value = target }); return; }
switch (source.Type) { case JTokenType.Object: var sourceObject = (JObject)source; var
targetObject = (JObject)target; var allKeys = new HashSet(sourceObject.Properties( ).Select(p =>
p.Name)); allKeys.UnionWith(targetObject.Properties( ).Select(p => p.Name)); foreach (var key
in allKeys) { if (sourceObject.TryGetValue(key, out var sourceValue)) { if
(targetObject.TryGetValue(key, out var targetValue)) {
GenerateOptimizedJsonPatchInternal(sourceValue, targetValue, patchOperations,
$“{currentPath}/{key}”); } else { patchOperations.Add(new JsonPatchOperation { Operation =
“remove”, Path = $“{currentPath}/{key}” }); } } else { patchOperations.Add(new
JsonPatchOperation { Operation = “add”, Path = $“{currentPath}/{key}”, Value = targetObje } }
break; case JTokenType.Array: var sourceArray = (JArray)source; var targetArray =
(JArray)target; // Check if both source and target arrays contain objects with an “Id” property
bool containsIdProperty = sourceArray.All(x => x.Type == JTokenType.Object && x[“Id”] !=
null) && targetArray.All(x => x.Type == JTokenType.Object && x[“Id”] != null); if
(containsIdProperty) { var sourceIdMap = sourceArray.ToDictionary(x => x[“Id”].ToString( ), x
=> x); var targetIdMap = targetArray.ToDictionary(x => x.Type == JTokenType.Object &&
x[“Id”] != null ? x[“Id”].ToString( ) foreach (var kvp in sourceIdMap) { if
(targetIdMap.ContainsKey(kvp.Key)) { GenerateOptimizedJsonPatchInternal(kvp.Value,
targetIdMap[kvp.Key], patchOperations, $“{currentPath}/{targetA } else {
patchOperations.Add(new JsonPatchOperation { Operation = “remove”, Path =
$”{currentPath}/{sourceArray.IndexO } } foreach (var kvp in targetIdMap) { if
(!sourceIdMap.ContainsKey(kvp.Key)) { patchOperations.Add(new JsonPatchOperation {
Operation = “add”, Path = $“{currentPath}/−”, Value = kvp.Value } } } else { var minLength =
Math.Min(sourceArray.Count, targetArray.Count); for (int i = 0; i < minLength; i++) {
GenerateOptimizedJsonPatchInternal(sourceArray[i], targetArray[i], patchOperations,
$“{currentPath}/{i}”); } if (sourceArray.Count > targetArray.Count) { for (int i =
targetArray.Count; i < sourceArray.Count; i++) { patchOperations.Add(new JsonPatchOperation
{ Operation = “remove”, Path = $“{currentPath}/{targetArray.Count} } } else if
(targetArray.Count > sourceArray.Count) { for (int i = sourceArray.Count; i <
targetArray.Count; i++) { patchOperations.Add(new JsonPatchOperation { Operation = “add”,
Path = $“{currentPath}/−”, Value = targetArra } } } break; case JTokenType.Null: // Both tokens
are null, no need to create a patch operation. break; default: if (!JToken.DeepEquals(source,
target)) { patchOperations.Add(new JsonPatchOperation { Operation = “replace”, Path =
currentPath, Value = target }); } break; } } public static JToken ApplyPatch(JToken source, List
patchOperations) { var patched = source.DeepClone( ); foreach (var operation in
patchOperations) { var pathSegments = operation.Path.Split(‘/’).Skip(1).ToArray( ); var path =
string.Join(“/”, pathSegments); switch (operation.Operation) { case “add”: case “replace”:
JToken parentToken = GetParentToken(patched, pathSegments); if (pathSegments.Last( ) == “−”)
{ ((JArray)parentToken).Add(operation.Value); } else { int index =
int.TryParse(pathSegments.Last( ), out int tempIndex) ? tempIndex : −1; if (index >= 0) {
((JArray)parentToken)[index] = operation.Value; } else { parentToken[pathSegments.Last( )] =
operation.Value; } } break; case “remove”: JToken tokenToRemove =
GetTokenByPath(patched, pathSegments); if (tokenToRemove != null)
{tokenToRemove.Remove( ); } break; default: throw new
InvalidOperationException($“Unknown patch operation: {operation.Operation}”); } } return
patched;}.

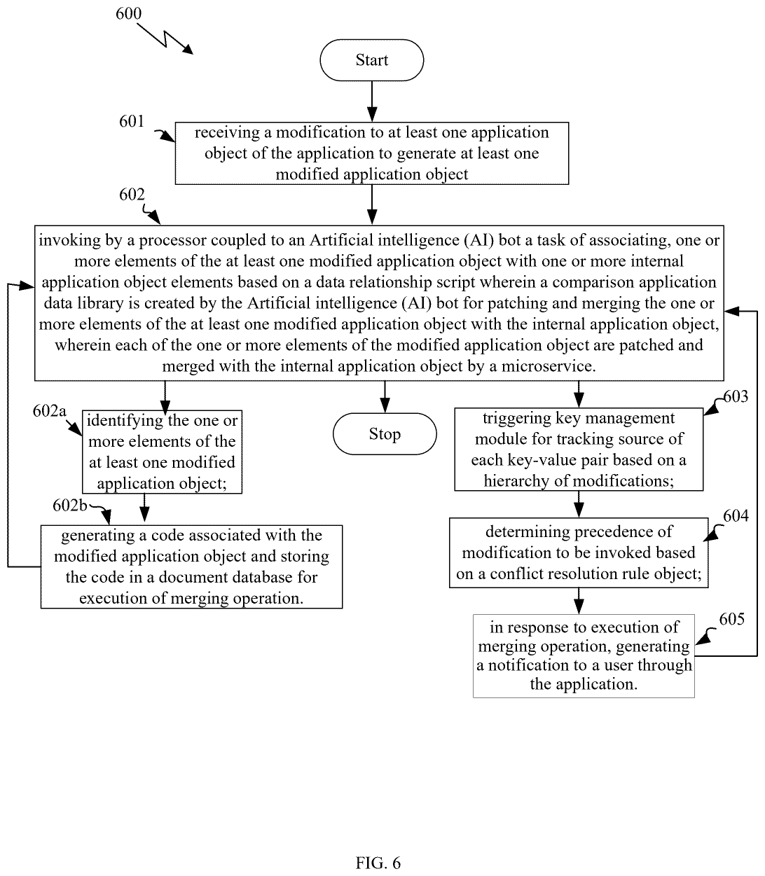

Referring to FIG. 6, a flowchart 600 depicting the method of patching and merging is provided in accordance with an embodiment of the invention. The method includes the step of S601, receiving a modification to at least one application object of the application to generate at least one modified application object. In step S602, invoking by a processor coupled to an Artificial intelligence (AI) bot a task of associating, one or more elements of the at least one modified application object with one or more internal application object elements based on a data relationship script wherein a comparison application data library is created by the Artificial intelligence (AI) bot for patching and merging the one or more elements of the at least one modified application object with the internal application object, wherein each of the one or more elements of the modified application object are patched and merged with the internal application object by a microservice. In step 602a, identifying the one or more elements of the at least one modified application object and in step 602b, generating a code associated with the modified application object and storing the code in a document database for execution of merging operation. In step 603, triggering key management module for tracking source of each key-value pair based on a hierarchy of modifications, in step 604, determining precedence of modification to be invoked based on a conflict resolution rule object, and in step 605, in response to execution of merging operation, generating a notification to a user through the application.

In an embodiment, the data relationship script is configured to associate the modified application objects and the internal application objects based on a plurality of metadata, data models and AI processing for enabling execution of patching and margining operation. The internal application objects include any UI application object or back-end application function object that are modified by the client domain or developer domain user to modify certain application functions of supply chain management applications. The application functions include procurement, inventory, logistics, warehouse, procurement, customers, supplier, retailers, distributors, resellers, co-packers and transportation, demand planning, supply planning, production planning, forecasting, smart factory and fulfillment planning etc. The plurality of nodes representing the functional elements interact with each other to structure the plurality of functions associated with the applications.

In an embodiment, the conflict resolution rule object is configured to cause the one or more processor to compare one or more modifications of the at least one application object based on the comparison data library to generate a matched pair of modifications wherein each matched pair includes an association of the one or more elements of the at least one modified application with one or more internal application object elements, and determine one or more edit operation for the at least one application object wherein an application object data script executable by the one or more processors is configured to transform the application based on the one or more elements of the modified application object through patching and merging.

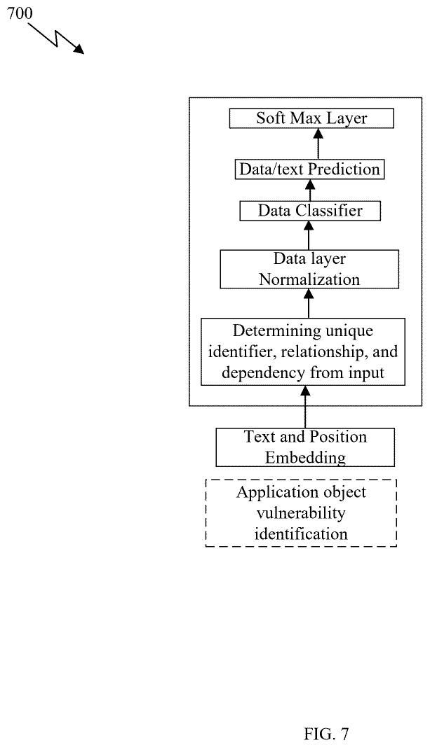

In an embodiment, the edit operation includes determining one or more elements of the modified application object as vulnerable elements, determining a unique identifier associated with the vulnerable element from a knowledge database, identifying based on the unique identifier, one or more nodes representing one or more application functions impacted by the vulnerable element, and executing the one or more edit operation for the at least one application object to patch and merge the application object. The knowledge database includes historical knowledge data and associated unique identifiers related to vulnerabilities triggered in the application due to modification of the application objects. In case the knowledge database is unable to map the element with a unique identifier, the one or more processor is configured to analyze the one or more elements for vulnerability based on LLM (large language model) agents. The processor always the one or more elements based on augmented LLM agents to provide accurate results. The vulnerability determination model flow 700 is shown in FIG. 7 with a SoftMax layer for vulnerability determination in patching and merging method of the invention. To process application object input with models, it is tokenized into a sequence of words associated with the one or more elements of the application objects. These tokens are then encoded as numbers and converted into embeddings, which are vector-space representations of the tokens that preserve their meaning. Next, an encoder transforms the embeddings of all the tokens into a context vector. The context vector allows the model to attend to one or more elements of the application object to capture its relationships and dependencies. Using the context vector, the model generates output based on the input. The context vector is large so it can handle very complex concepts, and with many layers in its encoder and decoder. The models may be based on deep learning that captures long-range dependencies between words, graphs elements and hence the model understands the context to determine vulnerability.

In an embodiment, the AI engine includes a code module configured for generating a plurality of protocols based on the modified application object, a plurality of metadata and data models associated with the modified application object. The protocols are generated for executing the patching and merging operation by the AI engine based on an AI based processing logic, wherein a controller coupled to the AI engine triggers an application UI loading component for conditionally loading at least one module on an application UI based on the vulnerability determination for patching and margining the application objects.

In a related embodiment, one or more functions of the application are recalibrated automatically in real-time once the patching and merging operation is executed. Further, the AI based processing logic includes a sequential, a parallel or switching based processing logic or a combination thereof. The AI based processing logic, integrates deep learning, predictive analysis, information extraction, planning, scheduling, impact analysis and robotics for processing the functions of the enterprise applications based on plurality of machine learning (ML) data models and large language models (LLM) agents.

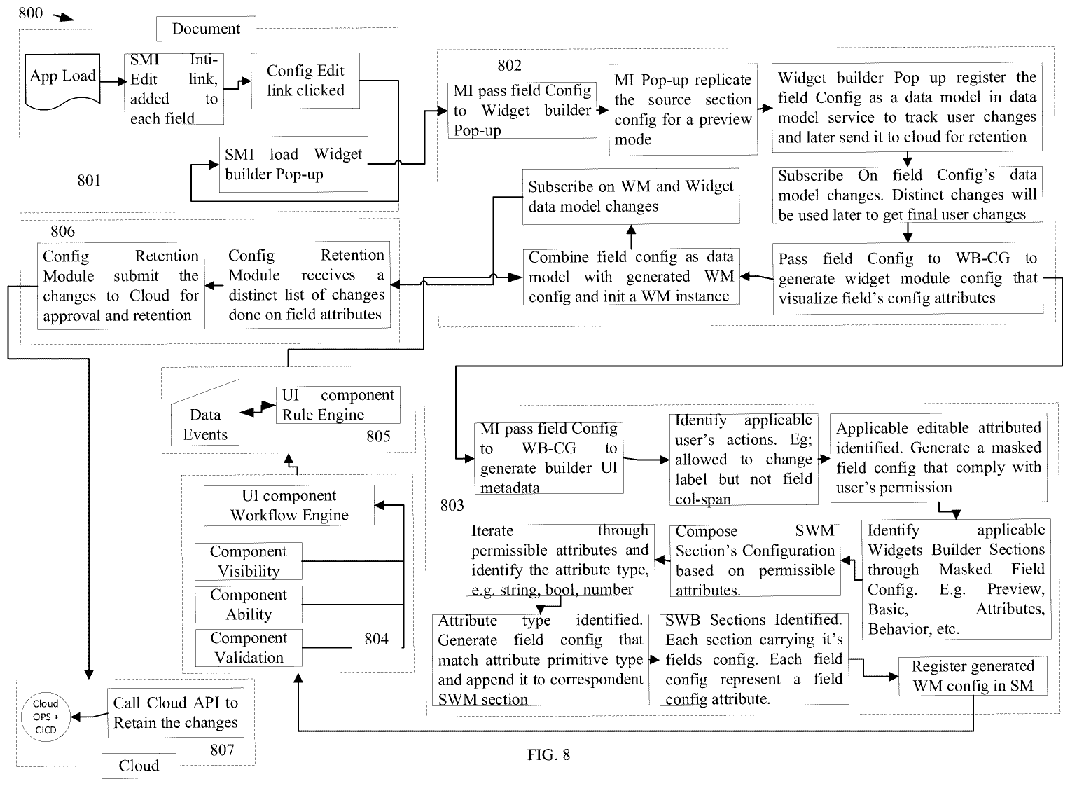

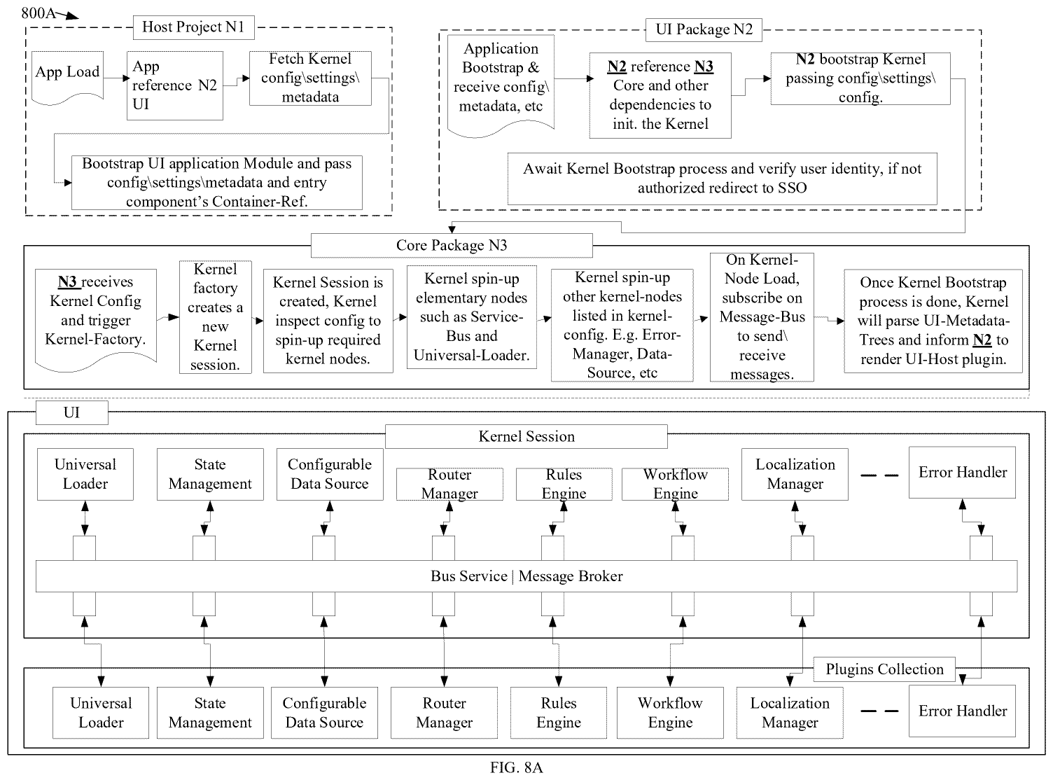

Referring to FIG. 8, a Widget builder platform is provided in accordance with an example embodiment of the invention. The Widget builder is a codeless platform package that allows client user and developer user to build, modify and customize application by modifying the application objects. Through Widget builder platform, users can change the field label, behavior [e.g. width] and attributes [e.g. visibility] as well as adding new widgets and fields and link these fields to external data models. The process flow includes injection of edit link if user\admin are authorized to edit form configuration in 801. When link is clicked MI load popup. In 802 Widgets Builder pass the field to config generation module to generate fields metadata for applicable\authorized attributes. In 803 WB Config Generator produces the metadata for a field and it pass the metadata to a Workflow engine to determine fields visibility. In 804 once workflow engine finalizes the rules, it will pass the metadata to a rules engine to verify field rules. In 805 rules engine finalize the rules check and pass the composed config back to SWB popup and await user changes. In 806 once the user finalizes their changes, WB popup will produce series of changes and send it to retention module. In 807, WB Retention module will submit changes to cloud for approval and then retention and finally for composition and regeneration.

In an embodiment, the metadata includes a Layout Metadata, Workflow metadata, Validation metadata, pluggable packages and modules metadata, application metadata, configurable data source metadata. The Layout metadata describes how a layout of an application will be rendered, using which UI elements. The workflow Metadata describes how UI elements will mutate its state based on the current application status. The Validation Metadata describes that the data model associated with a given UI Element should be validated. The Pluggable Packages & Modules Metadata carries a map of supported JS Modules (DEV/AOT) acting as a local Unpackaged gallery. The application Metadata describes app structure and rules defined by application admin user and it's different from a layout metadata. The Configurable Data Source Metadata describes the applicable data endpoints for a given application or shared across apps.

In an embodiment, the configurable data sources feed of the system is responsible to abstract external data fetch/retention activities and introduce a metadata driven compassable data feed. The source shall be consumed by other core packages or plugins through massaging bus pattern 800A as shown in FIG. 8A. The messaging bus pattern includes node N1 as Host project that reference and invoke node “N2” UI Package. Host Project should NOT contain any logic, it is meant to deliver config\settings\metadata to N2. Node N2 is the UI package meant to combine plugins collection and kernel, also it shall host none-pluggable modules. Node N3 is a core package meant to control\manage low-level activities, such as Service-Bus, Universal-Loader, State-Management, etc. Kernel nodes must not be accessible to plugins\workspace\host instead communications happen through Service-Bus. Feeds receive a predefined massage structure to trigger a Data Source, merge data feeds when needed, message data and inform consumer when data is available, optionally resolved data could be registered in a state management repository for future data manipulation.

In an advantageous aspect, the configurable data source and the system of the present invention enables exposure of easy to use interface and APIs, handling of all data fetch/retention scenarios, accepting/parsing/execution of metadata that represent fetch/retention activities, incorporation of necessary reactive operators e.g to fork-join, concatenate reactive events, querying for a previously registered data source feed and if not expired then serve it from store management, resolution of dependency feeds e.g if Supplier details feed require some data from basic details feed which is not currently loaded, the Configurable data source fetches dependency feeds before triggering the original feed, interception of the fetch/retention activities and appending JWT token required to communicate with API's, application of multiple data manipulations through pluggable data massagers, notifying entities with the stats of their requests by sharing the message status e.g request received fetching, merging, massaging, completed etc. The configurable data source further enables determination of an expiration window for active feeds and refresh the data when feed expires, communication with a store management microkernel node to retain/operate on feeds, monitoring data fetch/retention activities for performance, error handling and statistical information.

In an exemplary embodiment, external APIs are triggered in server side to avoid sending sensitive tokens to front-end [E.g tokens to communicate with other APIs]. The configurable data source implementation enables automation of data fetch/detection activities through metadata, reduction in efforts by eliminating the need of coding to fetch/retain data and enforcement of standards by providing set of unified messages to fetch/transform/mutate/retain data.

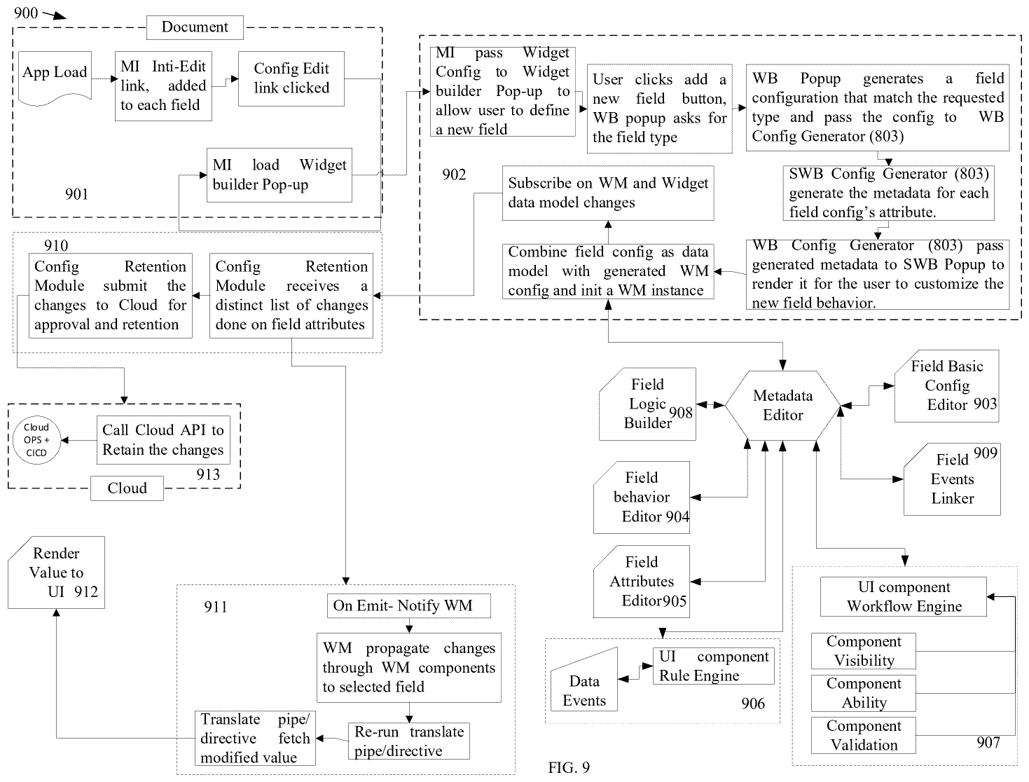

Referring to FIG. 9, in an example embodiment, a widget builder platform with multiple modules and process flow for adding a field on an application UI is provided in accordance with an embodiment of the present invention. The process flow includes injection of edit link if user\admin are authorized to edit form configuration in 901. When link clicked SMI load popup. In 902 Config dispatcher is dividing related config metadata into sections and send the generated metadata to appropriate editor. In 903 basic Config editor is responsible to edit basic configuration such as Id, label, etc. In 904 a behavior editor is responsible to edit field behavior and how it will appear on screen. In 905 attributes Editor is responsible to edit field attributes such as ability and visibility. In 906 a Rules Editor is responsible to define the rules related to new field. In 907 a Workflow Editor is responsible to link generated field with corresponding business rules. In 908, a Logic builder is where admin could define the business logic to be executed in certain events. In 909 an events linker is linking a field event such as change or select to a pre-defined business logic. In 910 Listen for admin activities and changes on Builder and keep track of changes being done for retention. In 911 when admin finalized all the changes, Config Retention module will notify Widgets Manager to reflect the changes. In 912 widgets Manager propagate the changes through child components and add the new field to the application UI/(DOM). In 913 distinct changes will be submitted to the cloud for composition, regeneration and retention.

In an exemplary embodiment, the changes are incorporated through patching and merging after vulnerability assessment of the changes submitted to the cloud.

In an exemplary embodiment, the present invention may be a system, a method, and/or a computer program product for data processing in enterprise application. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer system can include clients and servers. A client and server are generally remote from each other and typically interact through a network, such as the described one. The relationship of client and server arises by virtue of computer programs running on the respective computers and having a client-server relationship with each other. The client domain user and developer domain user have the ability to modify application objects and thereby managing the workflows.

In addition, the logic flows, node structures and other related structural flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A method of patching and merging of application object of an application developed by a codeless platform, the method comprises:
receiving a modification to at least one application object of the application to generate at least one modified application object; and
invoking by a processor coupled to an Artificial intelligence (AI) bot a task of associating, one or more elements of the at least one modified application object with one or more internal application object elements based on a data relationship script wherein a comparison application data library is created by the Artificial intelligence (AI) bot for patching and merging the one or more elements of the at least one modified application object with the internal application object,
wherein each of the one or more elements of the modified application object are patched and merged with the internal application object by a microservice.

2. The method of claim 1, wherein the application object includes front end or backend object components of the application including data object, meta data, application workflow components, and UI components associated with execution of operations in a supply chain application.

3. The method of claim 1, wherein patching and merging includes:
identifying the one or more elements of the at least one modified application object, and
generating a code associated with the modified application object and storing the code in a document database for execution of merging operation.

4. The method of claim 3, wherein patching and merging further comprises:
triggering a key management module for tracking source of each key-value pair of the application object based on a hierarchy of modifications;
determining precedence of modification to be invoked based on a conflict resolution rule object;
and
in response to execution of merging operation, generating a notification to a user through the application.

5. The method of claim 4, wherein the conflict resolution rule object is configured to cause the one or more processor to:
compare one or more modifications of the at least one application object based on the comparison data library to generate a matched pair of modifications wherein each matched pair includes an association of the one or more elements of the at least one modified application with one or more internal application object elements, and
determine one or more edit operation for the at least one application object wherein an application object data script executable by the one or more processors is configured to transform the application based on the one or more elements of the modified application object through patching and merging.

6. The method of claim 5, wherein the edit operation includes:
determining one or more elements of the modified application object as vulnerable elements;
determining a unique identifier associated with the vulnerable element from a knowledge database;
identifying based on the unique identifier, one or more nodes representing one or more application functions impacted by the vulnerable element, and
executing the one or more edit operation for the at least one application object to patch and merge the application object.

7. The method of claim 1, wherein data relationship script enables fetching information from a graph database wherein a hierarchical structure of the graphical database enables application development optimization based on identified relationship between the at least one modified application object and the one or more internal application object.

8. The method of claim 2, wherein the back-end object components include domain model, rule, application process model, State Machine, approval rule engine, and code snippet in microservice.

9. The method of claim 2, wherein the front-end object components include front rule User Interface (UI) behavior, form elements, labels, fields, sections, and buttons based on state machine.

10. The method of claim 2, wherein the data object of the application is stored as a graph structure enabling identification and association of data object relationships.

11. The method of claim 1, wherein the microservice includes application microservice such as custom logic, code generation, document creation, and API support authentication.

12. The method of claim 1, wherein the comparison application data library includes source data, destination data, versioning data, entity code and an identifier code wherein the identifier code is generated by the processor based on the data relationship script.

13. The method of claim 1, further comprises:
triggering by the AI bot, a domain model having one or more application entities with their relationship to other entities represented by associations wherein one or more annotations connected to the domain model enables identification of means by which the domain model is to be operated.

14. The method of claim 13, wherein structure of the domain model captures operational information and operational rules associated with the elements of the one or more internal application objects.

15. The method of claim 14, wherein application objects associated with the domain model enables support for spatial data editor (SAGA) and compensation of transaction to avoid orphan metadata.

16. The method of claim 15, wherein the bot deploys the front end and back-end object components of the application into a single node pattern with an application data structure and an augmented application data structure wherein the augmented application data structure shares one or more resources with the application data structure and enables modification of the application object.

17. The method of claim 1, further comprises:
creating one or more application object data relationship model as an ensemble of one or more data models for generating a relationship prediction data model to enable the data relationship script to associate one or more modified application object with internal application object by a bot.

18. The method of claim 17, further comprises:
identifying by an implementation bot, one or more application module intended to implement the modified application object based on an application object implementation prediction data model.

19. The method of claim 18, wherein the application object implementation prediction data model is generated by:
retrieving one or more historical application data object elements from a historical data object elements graph database;
extracting a plurality of relationship categories from the graph database to create a taxonomy of relationships associated with the application data object elements; and
invoking by the processor, one or more application module operational logic associated with each of the application module of the application based on the application object elements for generating an execution pattern between one or more application data object elements for generating the prediction data model.

20. A system for patching and merging of application object of an application developed by a codeless development platform, the system comprises:
one or more processors; and
one or more memory devices including instructions that are executable by the one or more processor for causing the processor to
receive a modification to at least one application object of the application to generate at least one modified application object; and
invoke by a processor coupled to an Artificial intelligence bot associating, one or more elements of the at least one modified application object with one or more internal application object elements based on a data relationship script wherein a comparison application data library is created by the AI bot for patching and merging the one or more elements of the at least one modified application object with the internal application object,
wherein each of the one or more elements of the modified application object are patched and merged with the internal application object by a microservice.

21. The system of claim 20, wherein the application object includes front end or backend object components of the application including data object, meta data, application workflow components, and UI components associated with execution of operations in a supply chain application.

22. The system of claim 20, wherein the one or more processor is configured to:
identify the one or more elements of the at least one modified application object, and
generate a code associated with the modified application object and storing the code in a document database for execution of merging operation.

23. The system of claim 20, wherein the one or more processor is configured to:
trigger key management module for tracking source of each key-value pair based on a hierarchy of modifications;
determine precedence of modification to be invoked based on a conflict resolution rule object;
and
in response to execution of merging operation, generate a notification to a user through the application.

24. The system of claim 20, further comprises:
a graph database configured for providing information based on the data relationship script wherein a hierarchical structure of the graphical database enables application development optimization based on identified relationship between the at least one modified application object and the one or more internal application object.

25. The system of claim 20, wherein the back-end object components include domain model, rule, application process model, State Machines, approval rule engine, and code snippet in microservice.

26. The system of claim 21, wherein the front-end object components include front rule User Interface (UI) behavior, form elements, labels, fields, sections, and buttons based on state machines.

27. The system of claim 21, wherein the data object of the application is stored as a graph structure enabling identification and association of data object relationships.

28. The system of claim 20, wherein the comparison data library includes source data, destination data, versioning data, entity code and an identifier code wherein the identifier code is generated by the processor based on the data relationship script.

29. The system of claim 20, further comprises:
a domain model having one or more application entities with their relationship to other entities represented by associations wherein one or more annotations connected to the domain model enables identification of means by which the domain model is to be operated.

30. The system of claim 29, wherein structure of the domain model captures operational information and operational rules associated with the elements of the one or more application objects.

31. The system of claim 30, wherein application objects associated with the domain model enables support for spatial data editor (SAGA) and compensation of transaction to avoid orphan metadata.

32. The system of claim 31, wherein the bot deploys the front end and back-end object components of the application into a single node pattern with an application data structure and an augmented application data structure wherein the augmented application data structure shares one or more resources with the application data structure and enables modification of the application object.

33. The system of claim 20, further comprises:
one or more application object data relationship model created as an ensemble of one or more data models for generating a relationship prediction data model to enable the data relationship script to associate one or more modified application object with internal application object by a bot.

34. The system of claim 33, further comprises:
an implementation bot configured for identifying one or more application module intended to implement the modified application object based on an application object implementation prediction data model.

35. The system of claim 34, wherein the processor is configured to generate the application object implementation prediction data model by:
retrieving one or more historical application data object elements from a historical data object elements graph database;
extracting a plurality of relationship categories from the graph database to create a taxonomy of relationships associated with the application data object elements; and
invoking by the processor, one or more application module operational logic associated with each of the application module of the application based on the application object elements for generating an execution pattern between one or more application data object elements for generating the prediction data model.

36. The system of claim 20, wherein the codeless development platform includes:
a plurality of configurable components; a customization layer; an application layer; a shared framework layer; a foundation layer; a data layer; a process orchestrator;
and
at least one processor configured to cause the plurality of configurable components to interact with each other in a layered architecture to:
customize the one or more Supply Chain Management (SCM) application based on the at least one modified application object and at least one operation to be executed using the customization layer;
organize at least one application service of the one or more Supply Chain Management (SCM) application with the at least one modified application object by causing the application layer to interact with the customization layer through one or more configurable components of the plurality of configurable components, wherein the application layer is configured to organize the at least one application service of the one or more Supply Chain Management (SCM) application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more supply chain management (SCM) application with the at least one modified application object using a process orchestrator to enable interaction of the plurality of configurable components in the layered architecture after patching and merging operation.

37. A non-transitory computer program product for patching and merging of one or more application object of an application developed by codeless platform to operate the one or application of a computing device with memory, the computer program product comprising a non-transitory computer readable storage medium having instructions embodied therewith, the instructions when executed by one or more processors causes the one or more processors to:
receive a modification to at least one application object of the application to generate at least one modified application object; and
invoke by a processor coupled to an Artificial intelligence bot associating, one or more elements of the at least one modified application object with one or more internal application object elements based on a data relationship script wherein a comparison application data library is created by the AI bot for patching and merging the one or more elements of the at least one modified application object with the internal application object,
wherein each of the one or more elements of the modified application object are patched and merged with the internal application object by a microservice.

38. The non-transitory computer program product of claim 37, wherein the method is performed in a cloud or cloud-based computing environment.
